(19) United States
(12) Patent Application Publication
(10) Pub. No.: US 2015/0266071 A1
(43) Pub. Date: Sep. 24, 2015

(54) System and Method for Forming a Metal Strip, and System for Forming an Electrical Wire or Transmission Line Including the Metal Strip

(71) Applicant: NeWire, Inc., Hendersonville, TN (US)

(72) Inventor: Robert Jay Sexton, Hendersonville, TN (US)

(21) Appl. No.: 14/664,607

(22) Filed: Mar. 20, 2015

Related U.S. Application Data
(60) Provisional application No. 61/968,304, filed on Mar. 20, 2014.

(51) Int. Cl. B21B 37/24; B21B 1/18; B21B 45/00; H01B 13/00; B21B 1/16

(52) U.S. Cl. CPC B21B 37/24; H01B 13/0006; B21B 1/166; B21B 45/004; B21B 1/18

(57) ABSTRACT

A system for forming a metal strip, includes an input device for inputting processing data including a critical dimension of the metal strip, a metal strip forming device for processing a metal rod into the metal strip, and a controller for controlling the metal strip forming device based on the input critical dimension of the metal strip.

### CROSS-REFERENCE TO RELATED APPLICATIONS

This application claims priority to U.S. Provisional Patent Application No. 61/968,304, which was filed on Mar. 20, 2014, and is incorporated by reference herein.

### BACKGROUND OF THE INVENTION

1. Field of the Invention

The present invention relates to a system and method for forming a metal strip and, more particularly, a system and method for forming (e.g., continuously forming) a metal strip in which a metal strip forming device is controlled based on an input critical dimension.

2. Description of the Related Art

Typically, the cost of thin strip metal has been significantly higher than other forms of processed metals, such as rod. The obvious reasons include the processing costs for the reduction of large ingots to thin strip, the difficulty and cost of standard annealing processes, the cost of cleaning and the significant handling cost differential between thin strip and rod.

The post process handling, contamination and shipping damages are also problematic. The processes and products that require narrow thin strip metals have to bear even greater costs for slitting and re-reeling and even more potential damage to the finished thin strip metal.

### SUMMARY

In view of the foregoing and other problems, disadvantages, and drawbacks of the aforementioned conventional systems and methods, an exemplary aspect of the present invention is directed to a system and method of forming a metal strip.

An exemplary aspect of the present invention is directed to a system for forming a metal strip, includes an input device for inputting processing data including a critical dimension of the metal strip, a metal strip forming device for processing a metal rod into the metal strip, and a controller for controlling the metal strip forming device based on the input critical dimension of the metal strip.

Another exemplary aspect of the present invention is directed to a method of forming a metal strip. The method includes inputting processing data including a critical dimension of the metal strip, processing a metal rod into the metal strip, and controlling the processing of the metal rod based on the input critical dimension of the metal strip.

Another exemplary aspect of the present invention is directed to a system for forming an electrical wire or transmission line. The system includes an input device for inputting processing data including a critical dimension of the metal strip, a metal strip forming device for processing a metal rod into the metal strip, a wire/line forming device which receives the metal strip from the metal strip forming device, and forms the electrical wire or transmission line from the metal strip, and a controller for controlling the metal strip forming device based on the input critical dimension of the metal strip, and controlling with wire/line forming device in coordination with a control of the metal strip forming device.

With its unique and novel features, the present invention provides a system and method of forming a metal strip which is more efficient (e.g., less costly) and effective than the conventional systems and methods of forming a metal strip.

### BRIEF DESCRIPTION OF THE DRAWINGS

The foregoing and other objects, aspects and advantages will be better understood from the following detailed description of the embodiments of the invention with reference to the drawings, in which:

FIG. 1A illustrates an alternating current (AC) electrical wire 10 (e.g., a 3-conductor wire embodiment), which may utilize a method of forming a metal strip according to an exemplary aspect of the present invention;

FIGS. 1B-1C illustrate a non-uniform transmission line 100 which may utilize a method of forming a metal strip according to an exemplary aspect of the present invention;

FIG. 1D illustrates an electrical wire 150 which may utilize a method of forming a metal strip according to an exemplary aspect of the present invention;

FIG. 2A illustrates a system 200 for forming (e.g., continuously forming) a metal strip (e.g., metal strips, conductors, wires, transmission lines, etc.), according to an exemplary aspect of the present invention;

FIG. 2B illustrates the controller 220 for controlling a system for forming a metal strip, according to an exemplary aspect of the present invention;

FIG. 3 illustrates a system 300 for forming a metal strip according to another exemplary aspect of the present invention;

FIG. 4A illustrates a system 400 for forming (e.g., continuously forming) a metal strip 205 (e.g., metal strips, conductors, wires, transmission lines, etc.), according to an exemplary aspect of the present invention;

FIG. 4B illustrates a sample look-up table 500 which may be stored in the memory device 222 and used in the system 400, according to an exemplary embodiment of the present invention;

FIG. 5A illustrates a system 500 for forming (e.g., continuously forming) a metal strip 205 (e.g., metal strips, conductors, wires, transmission lines, etc.), according to an exemplary aspect of the present invention;

FIG. 5B illustrates the feeding section 515-1, according to an exemplary aspect of the present invention;

FIG. 6 illustrates a system 600 for forming (e.g., continuously forming) metal strips 205 (e.g., metal strips, conductors, wires, transmission lines, etc.), according to another exemplary aspect of the present invention;

FIG. 7 illustrates a system 700 for forming (e.g., continuously forming) an electrical wire or transmission line, according to an exemplary aspect of the present invention;

FIG. 8A illustrates an electrical wire or transmission line 209a, according to an exemplary aspect of the present invention;

FIG. 8B illustrates an electrical wire or transmission line 209b, according to an exemplary aspect of the present invention; and

FIG. 9 illustrates a method 900 of forming a metal strip, according to an exemplary aspect of the present invention.

### DETAILED DESCRIPTION OF SOME EXEMPLARY EMBODIMENTS OF THE INVENTION

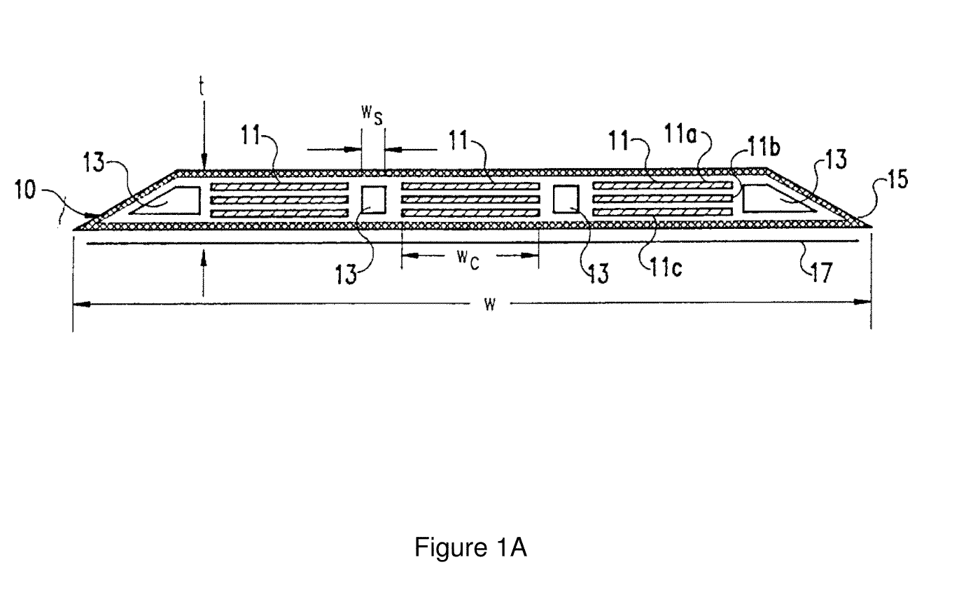

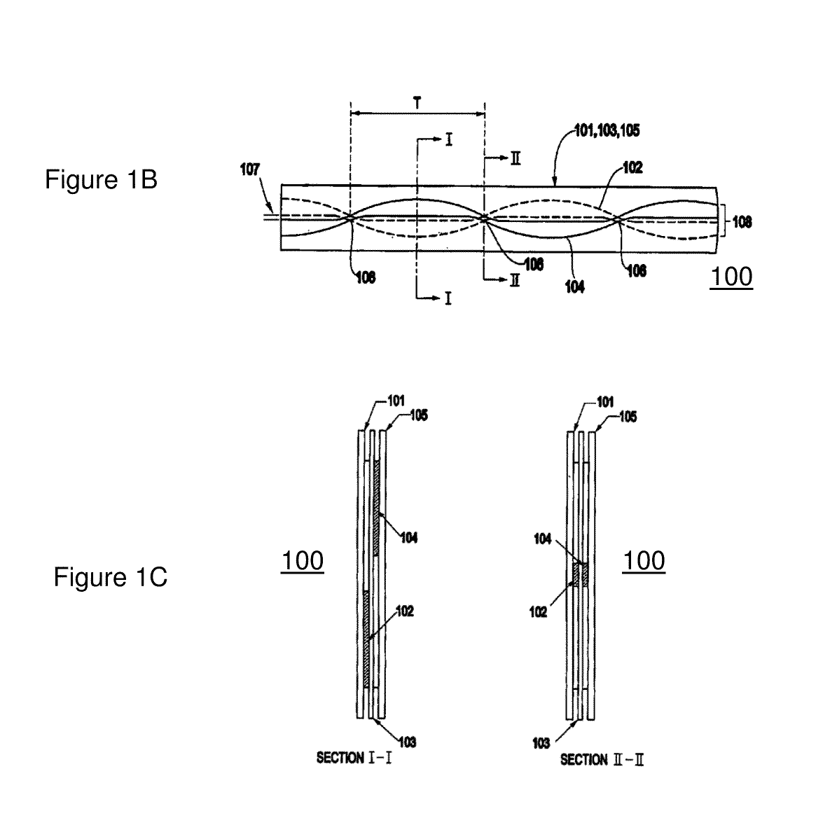

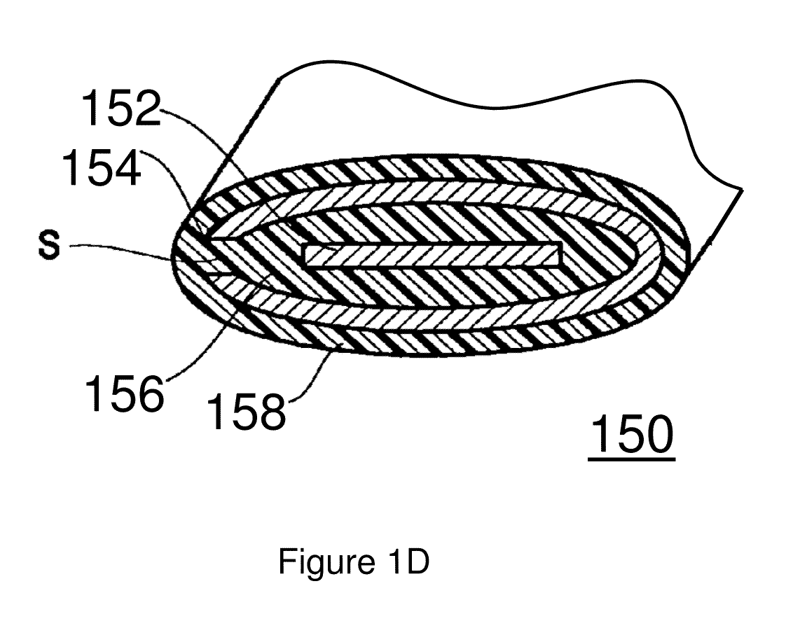

Referring now to the drawings, FIGS. 1-9 illustrate the exemplary aspects of the present invention.

An exemplary aspect of the claimed invention is directed to a method of forming a metal strip. The metal strip may be used, for example, in an electrical wire or transmission line for transmitting electrical signals (e.g., audio signals, video signals, data signals, etc.).

It should be noted that the term “metal strip” should be construed to mean an electrically conductive material which includes a metal such as copper, silver, gold, platinum, palladium, iron, aluminum, etc., or which includes a metal alloy (e.g., steel, bronze, etc.) or other material which includes a metal, and which may be used to transmit electrical power or signals such as audio signals, video signals and data signals.

### Electrical Wires and Transmission Lines

FIGS. 1A-1D illustrate various forms of electrical wire and transmission lines that may be utilize a metal strip formed according to an exemplary aspect of the present invention. It should be noted that FIGS. 1A-1D are merely examples and should not be considered as limiting the present invention in any manner. That is, the present invention may be used to form other metal strips which are not included in FIGS. 1A-1D.

In particular, FIG. 1A illustrates an alternating current (AC) electrical wire 10 (e.g., a 3-conductor wire embodiment), which may utilize a method of forming a metal strip according to an exemplary aspect of the present invention.

The electrical wire 10 includes a plurality of elongated and parallel spaced multi-layer conductors 11 (e.g., metal strips). The conductors 11 may include, for example, an AC ground conductor, an AC neutral conductor, and an AC power conductor.

The conductors 11 include one or a plurality of layers made with a metal strip (e.g., a copper strip, a copper alloy strip, etc.) that is about 0.0004 to about 0.020 inches thick. Three metal layers 11a, 11b, and 11c, are shown in FIG. 1 for example. The current and or signal carrying specifications of a particular application may be accomplished, for example, by varying the width (w_{c}) of the conductors 11, and/or varying the number of thin copper layers (e.g., metal strips) in each conductor 11, and/or varying the thickness (t) of the metal layers 11a, 11b, 11c.

An internal adhesive material 13 separates the flat conductors 11 as well as providing edge sealing of the outer flat conductors, and the adhesive material 13 and conductors 11 are surrounded by a thin layer of insulation material 15. In addition, an external adhesive layer 17 may be applied to the back of the electrical wire 10.

FIGS. 1B-1C illustrate a non-uniform transmission line 100 which may utilize a method of forming a metal strip according to an exemplary aspect of the present invention.

The non-uniform transmission line 200 includes at least one patterned conductive layer 102, 104 (e.g., metal strip), a dielectric layer 103 separating the layers 102, 104, and an insulating layer 101, 105 which covers the patterned conductive layers 102, 104 and dielectric layer 103. These conductive layers may form a transmission group 108. The patterned conductive layers 102, 104 may be formed, for example, of a metal such as copper, copper alloy, silver, etc., and may have a thickness of about 0.1 inches or less.

The patterned conductive layers 102, 104 may be formed in separate planes. Specifically, FIG. 1B shows patterned conductive layer 104 formed in a top horizontal plane and patterned conductive layer 102 formed in a bottom horizontal plane.

The patterned conductive layers 102, 104 have varying widths and spacing along the length of the line. For instance, the width of the patterned conductive layers 102, 104 is greater at cross section I-I than at cross section II-II, and the spacing between the patterned conductive layers 102, 104 is greater at cross section I-I than at cross section II-II.

As shown in FIG. 1B, there may be a horizontal spacing 107 (e.g., offset distance) between the layers, and as shown in FIG. 1C, there may be a vertical spacing between the layers, which may be considered to be the thickness of the dielectric layer 103.

FIG. 1B shows the patterned conductive layer 102 crossing over the patterned conductive layer 104 at points 106 (e.g., crossover nodes 106) along the length of the line 100. For example, the period of this spacing arrangement may be given by the distance, T, between the crossover points 106.

FIG. 1D illustrates an electrical wire 150 which may utilize a method of forming a metal strip according to an exemplary aspect of the present invention.

The electrical wire 150 includes an electrifiable conductor 152 (e.g., metal strip) which is capable of connecting to a source or electrical current and carrying (e.g., delivering) an electrical current or electrical signal (e.g., an AC or DC power supply or an electrical communication signal such as a voice or data transmission signal). The electrical wire also includes a return conductor 154 (e.g., metal strip), and insulating layers 156, 158, in a stacked configuration with the electrifiable conductor 152. At least some of these layers may be brought together (e.g., mated together by crimped, bonded, etc.) along a longitudinal edge of the wire 150.

The return conductor 154 may include a plurality of return conductors, and is formed such that the electrifiable conductor 152 is at least substantially entrapped (e.g., enveloped, surrounded, encased) by the return conductors 154, so that the electrifiable conductor 152 cannot be contacted with a foreign object (e.g., a nail, screw, staple, etc.) without first touching the one of the return conductors 154.

A distance (S) may be formed between the ends of the return conductor 154. That is, the electrifiable conductor 152 does not have to be completely entrapped by the return conductors 154.

### System for Forming a Metal Strip

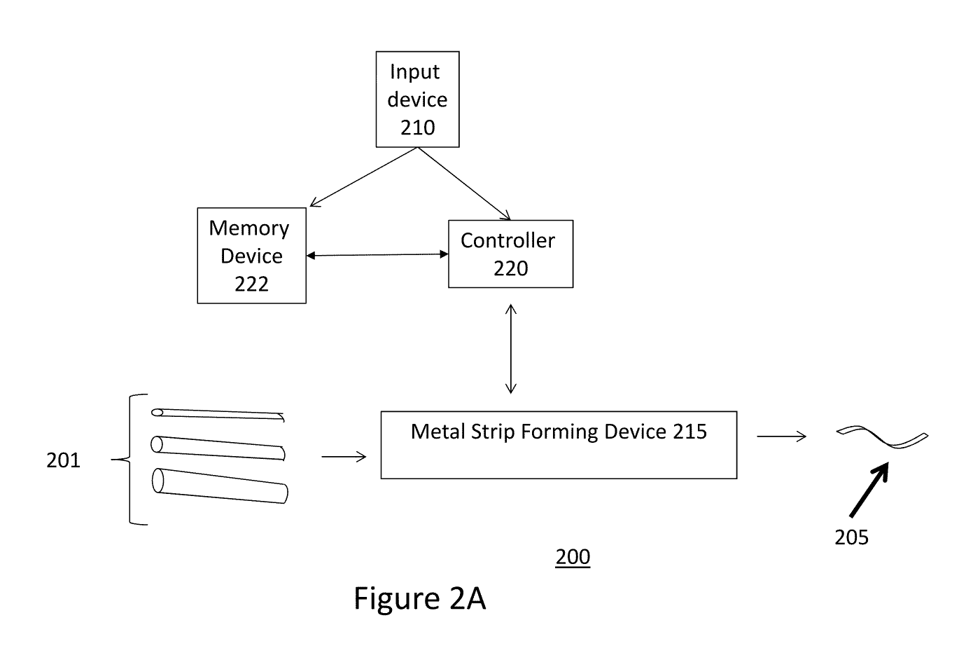

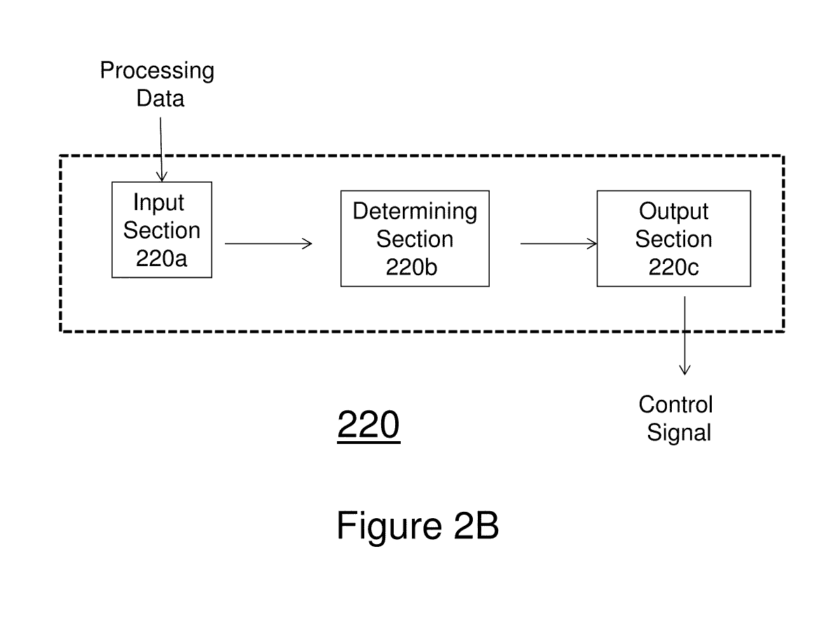

Referring again to the drawings, FIG. 2A illustrates a system 200 for forming (e.g., continuously forming) a metal strip (e.g., metal strips, conductors, wires, transmission lines, etc.), according to an exemplary aspect of the present invention.

As illustrated in FIG. 2A, the system 200 includes an input device 210 for inputting processing data including a critical dimension of the metal strip 205, a metal strip forming device 215 for processing (e.g., continuously processing) a metal rod 201 into the metal strip 205, and a controller 220 for controlling the metal strip forming device 215 based on the input critical dimension of the metal strip 205.

The system 200 may also include a memory device 222 which may be accessible by the input device 210 and the controller 220. The memory device 224 may store, for example, data which may be used by the controller 220 to control an operation in the metal strip forming device 215.

The system 200 may use specific gauge metal rod to create specific width or thickness thin strip metal as an inline process to many industries. The specific gauge metal rod may be readily available. By using readily available specific gauge metal rod, the present invention may greatly reduce the cost and processes of manufacturing the metal strip to specific parameters. The system 200 may utilize a process which is relatively clean and compact compared to conventional annealing processes. The annealing process of the present invention may also require less process time and distance and energy requirements than conventional annealing processes. The process utilized by the system 200 may also eliminate the need to slit the metal strip as a secondary process. The annealing process may also be performed “inline” and thereby, reduce re-reeling, handling, shipping requirements and damage, as compared to a conventional manufacturing processes. The system 200 may provide a significant advancement for numerous metal strip requirements and applications, globally.

Referring again to FIG. 2A, the input device 210 may include, for example, a keyboard, mouse, touchscreen, etc. The input device 210 may be used by the user to input data and/or instructions into the memory device 222 and/or the controller 220, for controlling an operation in the metal strip forming device 215. The input data may include a critical dimension of the metal strip 205, and may also include a preferred configuration of an electrical wire or transmission line which includes the metal strip, a preferred thickness of the metal strip 205, a preferred width of the metal strip 205, a preferred type of metal (e.g., copper, aluminum, steel, etc.) to be used in forming the metal strip 205, a preferring feeding rate for the metal rod 201, etc.

The memory device 222 may include, for example, random access memory (RAM), read-only memory (ROM), etc., and may be used to store the data and/or instructions which have been input by the input device 210. In addition, the memory device 222 may store the current settings of the system 200, history data (e.g., a history of the settings of the system 200, a history of the operation of the system, a history of maintenance of the system, and so on. The memory device 222 may also include an operating system application which may be executed by the controller 220 (e.g., CPU) to control an operation in any of the elements of the system 200.

The memory device 222 may also be accessed by the controller 220 which may update, erase and/or add to the data and instructions which are stored in the memory device 222. For example, the metal strip forming device 215 may include various sensors and detectors which may be used by the controller 220 to perform an operation in the metal strip forming device 215. The data may be fed back to the controller 220 from the metal strip forming device 215. The controller 220 may store the data generated by the sensors and detectors in the memory device 222, and may use the data to adjust (e.g., fine tune) the operating parameters for the metal strip forming device 215.

FIG. 2B illustrates the controller 220 for controlling a system for forming a metal strip, according to an exemplary aspect of the present invention. As illustrated in FIG. 2B, the controller 220 includes an input section 220a for inputting processing data including a critical dimension of the metal strip, a determining section 220b which determines a processing parameter (e.g., feed rate, annealing temperature, tension applied to the metal rod 201, etc.) based on the input processing data, and an output section 220c which outputs a control signal for controlling a processing of the metal rod 201 based on the determined processing parameter.

The controller 220 may include, for example, a microcontroller, electronic control unit (ECU), microprocessor, central processing unit (CPU), computer, etc. The controller 220 may include the hardware and software needed to control an operation (e.g., all of the operations) in the metal strip forming device 215. In particular, the controller 220 may include an integrated circuit containing a processor core, memory, and programmable input/output peripherals, which may operate together to control an operation of the metal strip forming device 215.

The controller 220 may be connected (e.g., by wire or wirelessly) to various sensors, detectors, motors, thermostats, gauges, transducers and valves which are used by the metal strip forming device 215 to perform an operation. The controller 220 may provide the system 200 with an ability to accurately, verifiably and repeatedly control the metal strip forming process to provide a metal strip 205 having a desired thickness, width, pattern and configuration, and desired physical properties such as hardness, tensile strength and elongation.

The controller 220 may receive one or more input critical dimensions of the metal strip 205 (e.g., width, thickness, etc.) from the input device 210, and may select a size (e.g., wire gauge) and type (e.g., copper, steel, aluminum, etc.) of metal rod 201 to process in order to form the desired metal strip 205.

In particular, the controller 220 may include a processor which may execute computer-readable instructions that are stored, for example, in the memory device 222 to control an operation in the metal strip forming device 215.

The metal rods 201 may be wound, for example, around a spool and fed (e.g., continuously fed) into the metal strip forming device 215. The metal rods 201 may include, for example, copper rod, aluminum rod and steel rod, and may include a plurality of different diameters.

It should be noted that although FIG. 2A illustrates a circular cylindrical metal rod 201, this is not intended to be limiting. That is, the metal rods 201 may include other cross-sectional shapes such as a square, oval, rectangle, etc.

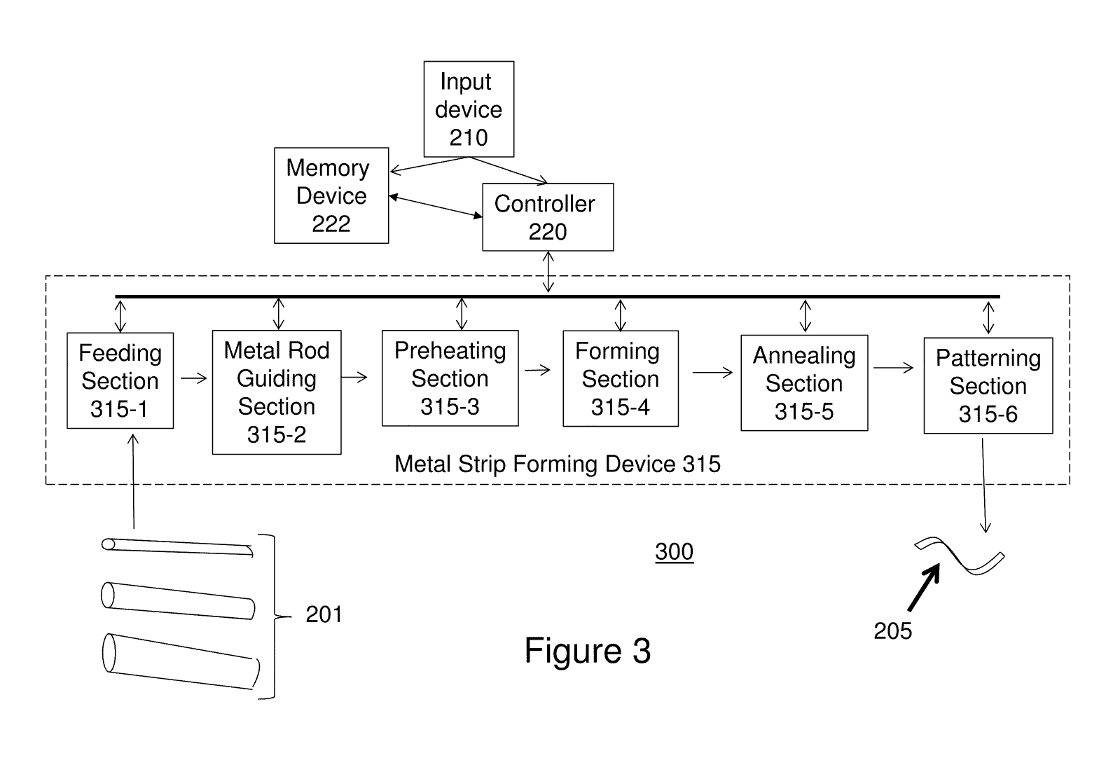

Referring again to the drawings, FIG. 3 illustrates a system 300 for forming a metal strip according to another exemplary aspect of the present invention.

As illustrated in FIG. 3, the system 300 includes an input device 210, controller 220 and memory device 222, which are discussed above. In addition, the memory device 222 may store the current settings of the

The system 300 also includes a metal strip forming device 315 which includes a feeding section 315-1 which feeds (e.g., pushes) the metal rod 201 through the various sections of the metal strip forming device 315. The feeding section 315-1 may include, for example, an automated feeder which may be controlled by the controller 220 based on data which has been input by the user such as a feed rate, a preferred thickness or width, etc., by using the input device 210, or based on data which has been stored in the memory device 222 or calculated by the controller 220.

The metal strip forming device 315 may also include a metal rod guiding section 315-2 which selects the type and gauge of metal rod 201 to be used in the metal strip 205, from among a plurality of possible types and gauges of metal rods 201. The guiding section 315-2 may be controlled by the controller 220 so as to guide the selected metal rod 205 into the metal strip forming device 315. The metal rod 301 may be automatically selected by the controller 220 and have a type and gauge based on data which has been input by the user such as a feed rate, a preferred thickness or width, etc., by using the input device 210, or based on data which has been stored in the memory device 222 or calculated by the controller 220.

The metal strip forming device 315 may also include a preheating section 315-3 which may preheat the selected metal rod 201, in order to prepare the selected metal rod 201 to be formed to a preferred thickness and width. The preheating section 315-3 may be controlled by the controller 220 so that that preheating section 315-3 may heat (e.g., automatically heat) the metal rod 201 based on data which has been input by the user such as a feed rate, a preferred thickness or width, etc., by using the input device 210, or based on data which has been stored in the memory device 222 or calculated by the controller 220.

The metal strip forming device 315 may also include a forming section 315-4 which may form the preheated metal rod 201 to a preferred thickness and width. The forming section 315-4 may be controlled by the controller 220 so that that forming section 315-4 may form (e.g., automatically form) the metal strip 205 to have a width and thickness based on data which has been input by the user such as a feed rate, a preferred thickness or width, etc., by using the input device 210, or based on data which has been stored in the memory device 222 or calculated by the controller 220.

The metal strip forming device 315 may also include a annealing section 315-5 which may anneal the metal strip 205 to set a preferred characteristic of the metal strip 205, such as ductility, hardness, internal stress, homogeneity, cold working properties, etc. The annealing section 315-5 may be controlled by the controller 220 so that that annealing section 315-5 may heat (e.g., automatically heat) the metal strip 205 based on data which has been input by the user such as a feed rate, a preferred thickness or width, etc., by using the input device 210, or based on data which has been stored in the memory device 222 or calculated by the controller 220.

The metal strip forming device 315 may also include a patterning section 315-6 which may pattern the metal strip 205 to have a preferred pattern (e.g., see FIG. 1B). The patterning section 315-6 may be controlled by the controller 220 so that that patterning section 315-6 may pattern (e.g., automatically pattern) the metal strip 205 based on data which has been input by the user such as a feed rate, a preferred thickness or width, etc., by using the input device 210, or based on data which has been stored in the memory device 222 or calculated by the controller 220.

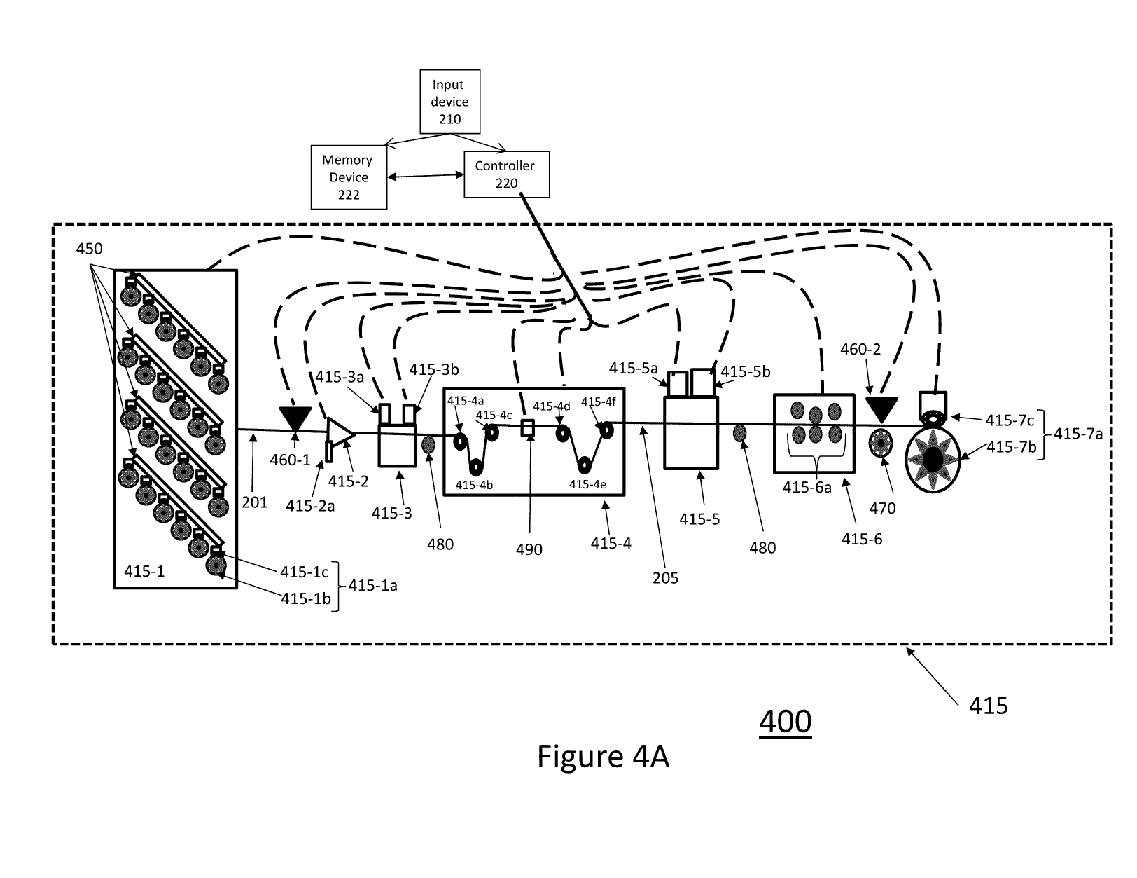

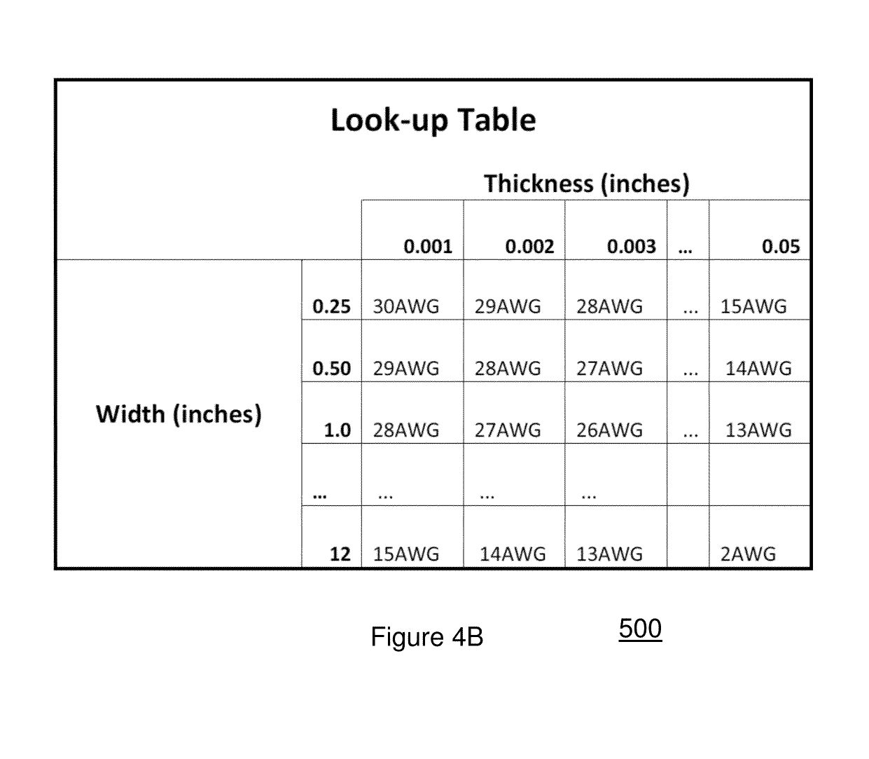

FIG. 4A illustrates a system 400 for forming (e.g., continuously forming) a metal strip 205 (e.g., metal strips, conductors, wires, transmission lines, etc.), according to an exemplary aspect of the present invention.

As illustrated in FIG. 4A, the system 400 includes the input device 210, the controller 220 which may select a metal rod 201 from among a plurality of metal rods 201 based on input parameters (e.g., parameters input by the user), and the memory device 222, all of which are discussed above.

The system 400 also includes a metal strip forming device 415 which includes a feeding section 415-1 which feeds (e.g., pushes) the metal rod 201 through the various sections of the metal strip forming device 415, a guiding section 415-2 which guides the selected metal rod 201 out of the feeding section 415-1, a preheating section 415-3 which preheats the selected metal rod 201, a forming section 415-4 which forms the selected metal rod 201 into a metal strip 205, an annealing section 415-5 which anneals the metal strip 205, a patterning section 415-6 which patterns the annealed metal strip 205, and a receiving device 415-7a (e.g., receiving roll, cylinder, spool, etc., and a motor for rotating the receiving roll, cylinder, spool, etc.) which receives the metal strip 205 from the patterning section 415-6.

It should be noted that some sections of the metal strip forming device 415 may be omitted or deactivated (e.g., not involved in the processing of the metal rod 201) in some cases. For example, the guiding section 415-2, the preheating section 415-3, the patterning section 415-6 and the receiving device 415-7a may be omitted or replaced in some cases. It should also be noted that some of the sections 415-2 to 415-6 may be rearranged to some extent and still provide the desired metal strip 205.

The system 400 may also include other features, such as inline cleaning and secondary preparation processes (e.g., pre-process treating of the metal rod 201, and post-process treating of the metal strip 205), which are not illustrated in FIG. 4A.

The system 400 may also be used in conjunction with a continuous metal rod casting process, in which case the feeding section 415-1 would be replaced with a process that forms the selected metal rod 201 based on the user input, and then the formed metal rod 201 is fed into the metal strip forming device 415. The system 400 may also be used in conjunction with an electrical wire or transmission line forming process, which receives the metal strip 205 formed by the metal strip forming device 415, and uses the metal strip 205 to form an electrical wire or transmission line (e.g., see FIGS. 1A-1D).

The system 400 may utilize pre-manufactured metallic rod 201 of specific gauge and type to create application specific and dimensionally correct continuous thin strip metal. The system 200 can support a variable number of metallic rod inputs and thin strip metal outputs, depending on application.

The metallic rod 201 may be preheated for faster (shorter length) processing and the finished thin strip metal can be fully annealed, cleaned and potentially pre-treated for the next manufacturing stage as part of an inline process.

The system 400 will allow for the selection of the level of finished thin strip metal annealing, from full hard to fully annealed, and can use different sources of heating for its processes including, resistance, inductive, ultrasonic, plasma, microwave, infrared, magnetic, fuel cell and other emerging heating sources.

The thin strip metal dimensions for the metal strip 205 in the system 400 may be significantly less than existing equipment for application acceptable thin strip metal. The bulk of the applications have a thicknesses range from 0.02 mm to 0.25 mm and width ranges from 2.5 mm to 152.4 mm. The system 400 may use metal rod 2 including input metallic rod having a diameter in a range from 0.255 mm to 6.544 mm.

The system 400 may have the ability to very accurately (within the design limit parameters, based on state of the art measuring systems) select dimensions of the finished thin strip metal, width and thickness as well as selecting the most critical dimension, thickness or width (to allow for input rod diameter variations).

The system 400 may have a thin strip metal output that can either be reeled or connected and fed into another process or machine, thus allowing for a completely continuous process for the original equipment manufacturer (OEM).

### The Feeding Section

The feeding section 415-1 may include, for example, an automated feeder which may be controlled by the controller 220 based on data which has been input by the user such as a feed rate, a preferred thickness or width, etc., by using the input device 210, or based on data which has been stored in the memory device 222 or calculated by the controller 220.

As further illustrated in FIG. 4A, the feeding section 415-1 may include a plurality of feeding devices 415-1a. Each of the plurality of feeding devices 415-1a includes a metal rod holding structure 415-1b (e.g., spool, cylinder, etc.) which holds the metal rod, and a rotating mechanism 415-1c (e.g., an electric motor) which is connected to the metal rod holding structure 415-1b and causes the metal rod holding structure 415-1b to rotate and, thereby, feed the metal rod 201 held by the metal rod holding structure 415-1b into the metal strip forming device 415, under the control of the controller 220.

The feeding section 415-1 may also include a positioning device 450 which positions a feeding device 415-1a holding the selected metal rod into position near the metal rod guiding section 415-2. The position device 450 may include, for example, a horizontal position mechanism and a vertical position mechanism, to allow the positioning device 450 to accurately position the feeding device 415-1a vertically and horizontally.

The feeding section 415-1 may feed a type and size of metal rod 201 which is selected by the user, or a type and size of metal rod 201 which is selected by the controller 220 based on data input by the input device 210. The controller 220 may select (e.g., determine) the preferred metal rod 201, for example, by referring to a look-up table stored in the memory device 222.

FIG. 4B illustrates a sample look-up table 500 which may be stored in the memory device 222 and used in the system 400, according to an exemplary embodiment of the present invention. The look-up table 500 may indicate a gauge of wire rod 201 to be processed by the system 400 in order to attain a desired width and thickness of the metal strip 205.

Thus, for example, if a user indicates with the input device 210 that he desires to form a copper strip having a thickness of 0.001 inches and a width of 0.25 inches, then the controller 220 may refer to the look-up table 500 and determine that a 30 AWG copper rod should be used as a raw material. The controller 220 may then cause the positioning device 450 to position a feeding device 415-1a holding 30 AWG copper rod near to the metal rod guiding section 415-2. After the selected feeding device 415-1a is positioned, the controller 220 may then cause the rotating mechanism 415-1c to rotate the metal rod holding mechanism 415-1b, thereby feeding the 30 AWG copper rod into the metal rod guiding section 415-2.

It should be noted that the look-up table 500 may include a plurality of look-up tables. That is, the controller 220 may refer to different look-up tables in the memory device 222, depending upon the desired configuration of the metal strip 205 (e.g., uniform configuration, non-uniform configuration, etc.), or the desired type of metal (e.g., copper, steel, aluminum, etc.) in the metal strip 205. This may be necessary since, for example, the settings (e.g., feed rate of the feeding section 415-1, tension on the metal rod 201 in the forming section 415-4, etc.) needed to attain a desired metal strip 205 may vary depending upon the desired configuration of the metal strip 205 and the desired type of metal strip 205.

For example, the memory device 222 may store a first look-up table for forming a copper strip 205 with a uniform configuration (e.g., not patterned to have a non-uniform configuration), a second look-up table for forming a steel strip 205 with a uniform configuration, a third look-up table for forming an aluminum strip 205 with a non-uniform configuration, and so on.

The system 400 may also allow a user to select a width and thickness which is not necessarily included in the look-up table 500. In that case, the controller 220 may select the closest gauge of metal rod 201 to use, and then follow a predetermined algorithm for adjusting the settings of the system 400 to attain the desired metal strip 205. The predetermined algorithm may include, for example, referring to an adjustment look-up table stored in the memory device 222 and containing adjustments to be made by the controller 220 in order to attain the desired metal strip 205.

Alternatively, the controller 220 may include a calculating device (e.g., a processor) which performs a calculation to determine which settings of the system 400 to adjust in order to attain the desired metal strip 205.

For example, referring again for the look-up table 500 in FIG. 4B, if a user uses the input device 210 to indicate that he desires a copper strip 205 having a thickness of 0.001 inches and a width of 0.35 inches, the controller 220 may select a 30 AWG metal rod 201 to use as a raw material to form the copper strip 205 and, since the desired width of 0.35 inches is not listed in the look-up table 500, the controller 220 may adjust the settings of the system 400, such as by reducing the rate of rotation of the rotating mechanism 415-1c in order to reduce the feed rate of the 30 AWG metal rod 201, and/or by increasing a tension of a roller in the forming section 415-4, and/or by activating the patterning section 415-6 (e.g., trimming away an outer portion of the wire strip 205 in order to reduce a width of the wire strip 205), in order to attain the desired width of 0.35 inches.

It is important to note that the feed of the metal rod 201 in the system 400 may be totally or partly automated. That is, if the user inputs the desired parameters of the metal strip 205 (e.g., width, thickness, configuration, etc.), the system 400 may select a metal rod 201 from among a plurality of metal rods 201, position the feeding section 415-1 with the selected metal rod 201 for processing in the system 400, activate the feeding section 415-1 to begin a feeding of the metal rod 201 into the metal strip forming device 415, and set the operating conditions of the various sections 415-1 to 415-7a of the metal strip forming device 415, to provide the desired metal strip 205.

The system 400 may have the ability to accept various gauge metal rods 201 (AWG) or equivalent global diameter rod sizes. For example, the metal rods 201 that may be used in the system 400 may have a gauge in a range from about 2 AWG (6.544 mm) to about 30 AWG (0.255 mm). An initial target is about 5 AWG (4.621 mm) to about 24 AWG (0.511 mm). An initial range for the gauge of the metal rod 201 may be about 8 AWG (3.264 mm) to about 20 AWG (0.812 mm).

A thickness of the finished metal strip 205 may be in a range from 0.001″ (0.0254 mm) to 0.05″ (0.254 mm) or greater inches. In particular, a thickness for a FlatWire application (e.g., see FIGS. 1A-1D) may be in a range of 0.001 inch to 0.01 inch. A width of the metal strip 205 may be about 0.25 inches wide and wider. In particular, a width of the metal strip 205 may be in the range of 0.5 inches to 12 inches.

### The Guiding Section

The guiding section 415-2 may include, for example, a funnel-shaped guide which guides a leading edge of the selected metal rod 201 off of the metal rod holding structure 415-1b. The guiding section 415-2 may be integrally-formed, for example, with the feeding section 415-1.

The guiding section 415-2 may include a positioning device 415-2a which sets a horizontal and/or vertical position of the guiding section 415-2, and thereby sets a horizontal and vertical position of the metal rod 201 as it exits the guiding section 415-2. Thus, the controller 220 may control the horizontal and/or vertical position of the metal rod 201 by controlling the positioning device 415-2a.

### The Preheating Section

The preheating section 415-3 may include a heating chamber and a heater such as an electric heater, gas heater, oil heater, etc. formed in the heating chamber. The preheating section 415-3 may also include a temperature regulator 415-3a which regulates the temperature in the heating chamber by adjusting the heater, and a thermometer 415-3b which detects a temperature in the heating chamber.

The thermometer 415-3b is coupled to the temperature regulator 415-3a, and both the thermometer 415-3b and the temperature regulator 415-3a are coupled to the controller 220. If the controller 220 detects that the metal rod 201 needs to be softer in order to be formed to specification (e.g., desired width and thickness) in the forming device 415-4, then the controller 220 may cause the temperature regulator 415-3a to increase a temperature in the heating chamber, and if the controller 220 detects that the metal rod 201 needs to be harder in order to be formed to specification (e.g., desired width and thickness) in the forming device 415-4, then the controller 220 may cause the temperature regulator 415-3a to decrease a temperature in the heating chamber.

The preheating section 415-3 may provide a preheating process that makes the metal forming faster, easier and require less distance to form.

### The Forming Section

The forming section 415-4 may receive the selected metal rod 201 from the preheating section 415-3, and transform the selected metal rod 201 into the metal strip 205. The forming section 415-4 may include a plurality of rollers 415-4a to 415-4f which form (e.g., “flatten”) the metal rod 201 into the shape of the metal strip 205.

The plurality of rollers 415-4a to 415-4f may include, for example, dancer rollers and tension meter rollers both of which may be used to control a tension of the metal rod 201 in the forming device 415-4. The tension meter rollers may include a tension meter which measures a tension in the tension meter rollers and is communicatively coupled to the controller 220. The tension meter may transmit tension information (e.g., the amount of tension on the metal rod 201) to the controller 220, and the controller 220 may store the tension information in the memory device 222, and may adjust the position of the dancer rollers and/or other rollers in the plurality of rollers 415-4a to 415-4f (and/or the feed rate, and/or other settings in the metal strip forming device 415) based on the tension information, in order to adjust the tension on the metal rod 201 and/or to adjust the width and thickness of the metal strip 205.

The metal strip 205 exiting the forming device 415-4 will generally have the desired width and thickness as specified by the user with the input device 210.

### The Annealing Section

The annealing section 415-5 may receive the formed metal strip 205 from the forming section 415-4. The annealing section 415-5 may be arranged so that the annealing is performed after the metal strip has reached its thickness or width parameter, which should reduce the amount of time and heat required to anneal the metal strip 205.

The annealing section 415-5 may be part of an inline annealing process from initial heating for ease of forming (e.g., preheating section 415-3) to a finish range from full hard to fully annealed. The annealing section 415-5 may include a heat source which uses standard resistance and/or furnace heating, as well as more advanced and lower energy heat sources, such as plasma heating, infrared heating, ultrasonic heating, microwave heating or chemical heating.

In particular, the annealing section 415-5 may include, for example, a continuous annealing furnace including a heating chamber and one or more cooling chamber (e.g., an air-cooled chamber). To prevent oxidation of the metal strip 205, a gas mixture of 95% nitrogen and 5% hydrogen may be pumped into the heating chamber, to provide a substantially oxygen-free environment in the heating chamber.

The heating chamber may heat the metal strip 205 to a predetermined temperature which is set by the controller 220 based on the type of material of the metal strip 205 (e.g., copper, steel, aluminum, etc.). The controller 220 may also set the feed rate in the metal strip forming device 415 so as to control the duration of the annealing time of the metal strip 205.

For example, for a copper strip 205, the controller 220 may set the temperature in the heating chamber to be in a range from 150° C. to 250° C., and may set the feed rate such that the metal strip 205 remains in the heating chamber for 45 minutes to 75 minutes.

Similar to the preheating section 415-3, the heating chamber may include a heater such as an electric heater, gas heater, oil heater, etc. formed in the heating chamber. The heating chamber may also include a temperature regulator 415-5a which regulates the temperature in the heating chamber by adjusting the heater, and a thermometer 415-5b which detects a temperature in the heating chamber.

The thermometer 415-5b is coupled to the temperature regulator 415-5a, and both the thermometer 415-5b and the temperature regulator 415-5a are coupled to the controller 220 and are controlled by the controller 220. The user can use the input device to manually control the settings of the annealing section 415-5 (e.g., feed rate (duration in the heating chamber of the annealing section 415-5) and temperature in the heating chamber).

Alternatively, the system 400 may automatically set the conditions in the annealing section 415-5 based on history data or other data stored in the memory device 222, and/or based on data input by the user with the input device 210. For example, the user may use the input device 210 to input data such as a metal content analysis (e.g., purity analysis) for the selected metal rod 201, a desired width and thickness of the metal strip 205, a desired conductivity of the metal strip 205, a desired hardness of the metal strip 205, and a desired tensile strength of the metal strip 205. Based on the input data, the controller 220 (e.g., processor) may calculate an optimum settings for the annealing section 415-5 (e.g., feed rate (duration in the heating chamber of the annealing section 415-5), temperature in the heating chamber, duration in the cooling chamber and temperature in the cooling chamber).

Further, the resulting metal strip 205 may be tested for conductivity, hardness and tensile strength, and if the actual conductivity, hardness and tensile strength are substantially different than the desired conductivity, hardness and tensile strength, then the testing data may be fed back (e.g., manually or automatically) into the controller 220, and the controller 220 may refine its calculations based on the actual conductivity, hardness and tensile strength, so that in a future operation, the settings of the annealing section 415-5 will be adjusted to more reliably attain the desired conductivity, hardness and tensile strength for the metal strip 205.

### The Patterning Section

The patterning section 415-6 may receive the annealed metal strip 205 from the annealing section 415-5, and may include a pressing tool or cutting tool for pressing or cutting the metal strip 205 to have a desired width, pattern, configuration, etc. In particular, the patterning section 415-6 may include a plurality of patterning roller dies 415-6a for pressing or cutting the metal strip 205.

For example, a patterning roller die 415-6a of the plurality of patterning roller dies 415-6a may be used to pattern the metal strip 205 to have the pattern of the patterned conductive layers 104, 106 in FIG. 1B.

The patterning section 415-6 may be controlled by the controller 220. Thus, based on a user input, the controller 220 may control the patterning section 415-6 to be activated or deactivated in order to provide the desired pattern (or lack of pattern) of the metal strip 205. In particular, the controller 220 may control the patterning section 415-6 to engage or disengage one or more of the plurality of patterning roller dies 415-6a, and/or adjust the pressure which is applied by the patterning roller dies 415-6a onto the metal strip 205.

### The Cutting Tools

Referring again to FIG. 4A, the system 400 may also include cutting tool 460-1 for cutting metal rod 201 in the metal strip forming device 415, and cutting tool 460-2 for cutting a metal strip 205 in the metal strip forming device 415.

The cutting tools 460-1 and 460-2 may include, for example, a mechanical cutting tool (e.g., a blade), a torch, or a laser cutting tool, and may be used, for example, in stopping an operation in the metal strip forming device 415, and/or in beginning a new operation in the metal strip forming device 415. That is, a user may use the input device 210 to input a “stop” instruction to stop the processing of a metal rod 201, in which case, the controller 220 may receive the instruction and cause the various sections of the metal strip forming device 415 to stop the operations (e.g., feeding, preheating, forming, annealing, patterning) being performed thereby.

Before stopping the operations, the controller 220 may cause the cutting tool 460-1 to cut the metal rod 201, and may cause the portion of the metal rod 201 remaining in the metal strip forming device 415 to be completely processed into a metal strip 205 and loaded onto the receiving device 415-7a. After the controller 220 has detected that the remaining metal rod 201 has been completely processed (e.g., after a predetermined amount of time has elapsed since the user inputted the “stop” instruction), the controller 220 may stop the operations in the metal strip forming device 415.

The metal strip forming device 415 may also include one or more width and thickness detectors 490 which detects a width and thickness of the metal strip 205 formed by the forming device, and may include a scrap metal take-up roll 470 for taking up scrap metal, and feeder rollers 480 for feeding the metal rod 201 and metal strip 205. Thus, for example, if a width and thickness detector 490 detects that the metal strip 205 is not to specification, then the controller 220 may cause the cutting tool 460-2 to cut the metal strip 205, and engage the feeder rollers 480, the scrap metal take-up roller 470, and/or the forming rollers 415-4a to 415-4f in the forming section 415-4, and cause the cutting tool 460-2 to guide the metal strip 205 onto the scrap metal take-up roll 470. This may allow the system 400 to avoid commingling good and bad (e.g., not to spec) portions of the metal strip 205 on the receiving device 415-7a.

Similar to the plurality of feeding devices 415-1a, the receiving device 415-7a includes a metal strip holding structure 415-1b (e.g., spool, cylinder, etc.) which holds the metal strip, and a rotating mechanism 415-7c (e.g., an electric motor) which is connected to the metal strip holding structure 415-7b and causes the metal strip holding structure 415-7b to rotate and, thereby, “take up” the metal strip 205 onto the metal strip holding structure 415-7b, under the control of the controller 220.

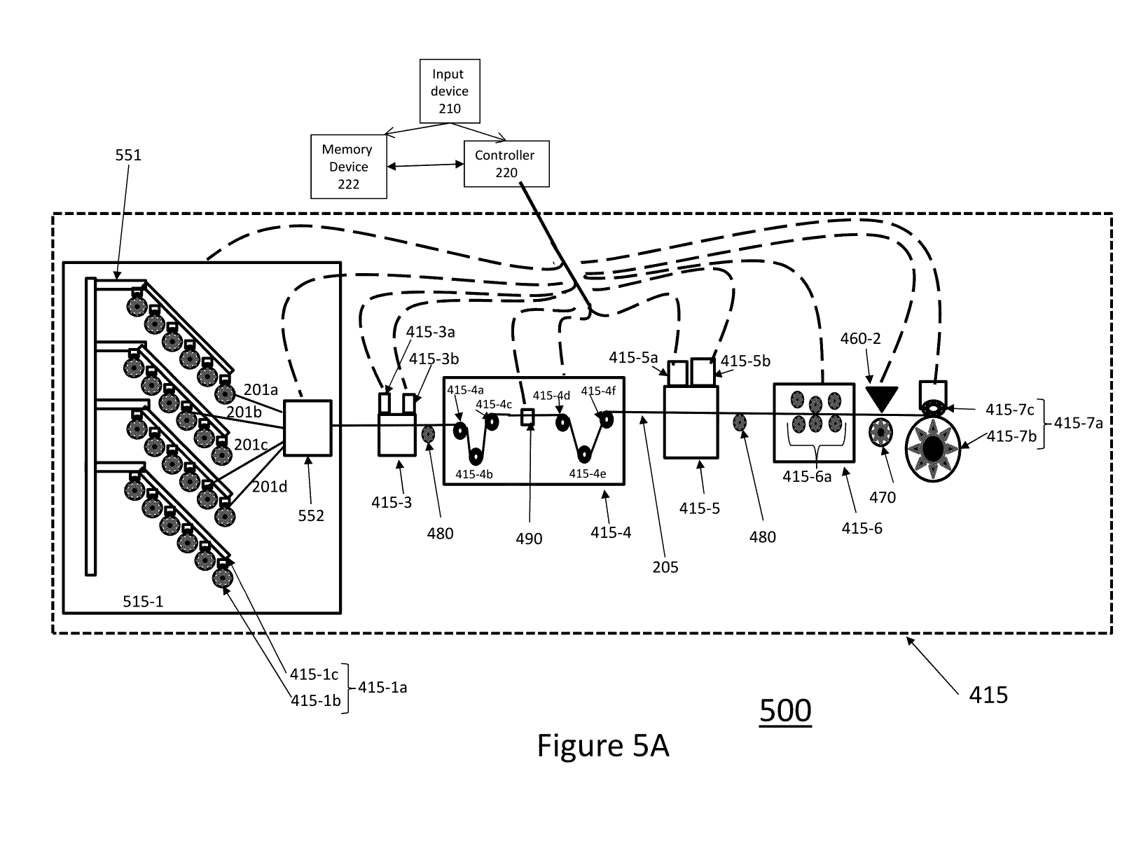

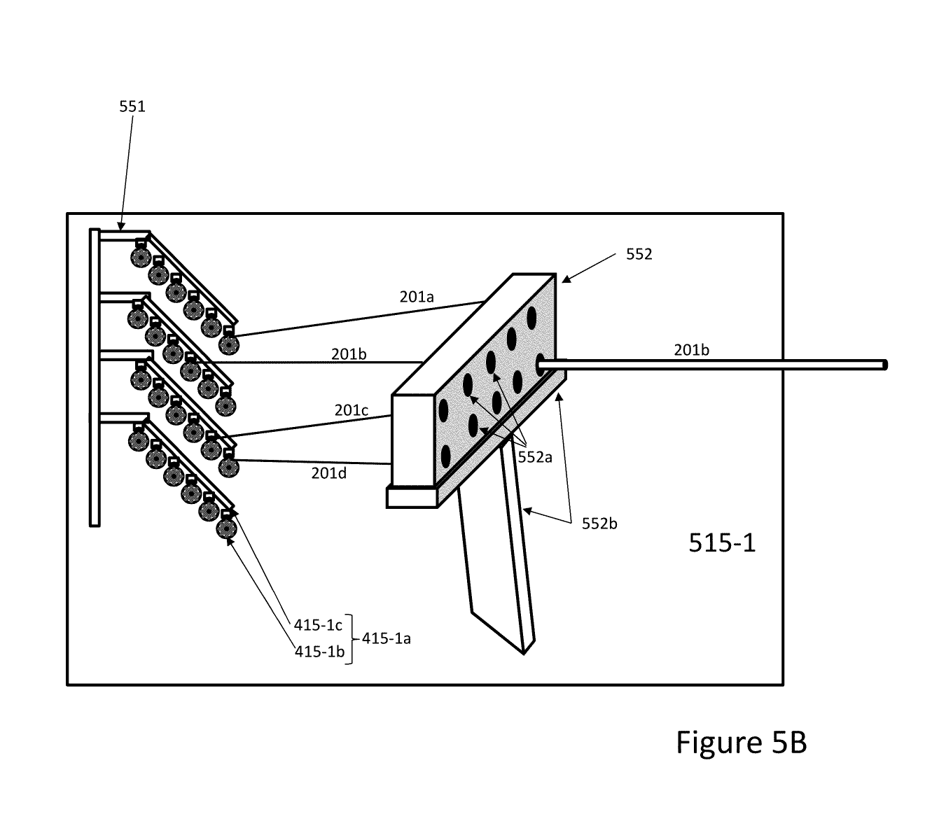

Referring again to the drawings, FIG. 5A illustrates a system 500 for forming (e.g., continuously forming) a metal strip 205 (e.g., metal strips, conductors, wires, transmission lines, etc.), according to another exemplary aspect of the present invention.

The system 500 may include many of the same features as the system 400. However, the system 500 includes a feeding section 515-1 for feeding the metal rods into the preheating section 415-3.

In particular, the feeding section 515-1 may include, for example, an automated feeder which may be controlled by the controller 220 based on data which has been input by the user such as a feed rate, a preferred thickness or width, etc., by using the input device 210, or based on data which has been stored in the memory device 222 or calculated by the controller 220.

As further illustrated in FIG. 5A, the feeding section 515-1 may include a support structure 551 for supporting (e.g., holding) the plurality of feeding devices 415-1a. The support structure 551 may include, for example, a bracket mounted on a wall, a table, a shelf, a tray, etc., which supports the feeding devices 415-1a as the feeding devices 415-1a are being rotated to supply the metal rod thereon into the preheating section.

FIG. 5B illustrates the feeding section 515-1, according to an exemplary aspect of the present invention.

As illustrated in FIG. 5B, the feeding section 515-1 includes a feeding tray 552 which includes a plurality of feeding slots 552a (e.g., holes, slits, etc.) through which the selected metal rod (or plurality of metal rods) may be fed to the preheating section 415-3. In particular, as illustrated in FIG. 5B, the ends of a plurality of metal rods 201a to 201d may be fed into the feeding tray 552 and maintained in the feeding tray 552 until they are selected by the controller 220 to be used in the metal strip forming device 415.

The feeding tray 552 may include, for example, a holding mechanism which holds the ends of the metal rods 201a to 201d in the plurality of feeding slots 552a, such as by friction or other force. For example, the feeding slots 552a may have vary in size (e.g., diameter) so that the size of the feeding slots 552a correspond to a size of the metal rod which is held (e.g., housed) therein. In particular, the size of a feeding slot 552a of the plurality of feeding slots 552a may be just greater than the size of the metal rod held therein in order to inhibit the end of the metal rod from sliding out of its feeding slot 552a.

The feeding tray 552 may also include a positioning device 552b which is controlled by the controller 220. The positioning device 552b may be connected to a side of the feeding tray 552 and position the feeding tray 552 (under the direction of the controller 220) so that the metal rod selected by the controller 220 (e.g., metal rod 201b in FIG. 5B) is positioned properly to be fed into the preheating section 415-3. The positioning device 552b may include, for example, a horizontal position mechanism and a vertical position mechanism, to allow the positioning device 552b to accurately position the feeding tray 552 vertically and horizontally, so that the selected metal rod (e.g., metal rod 201b) is accurately fed into the preheating section 415-3.

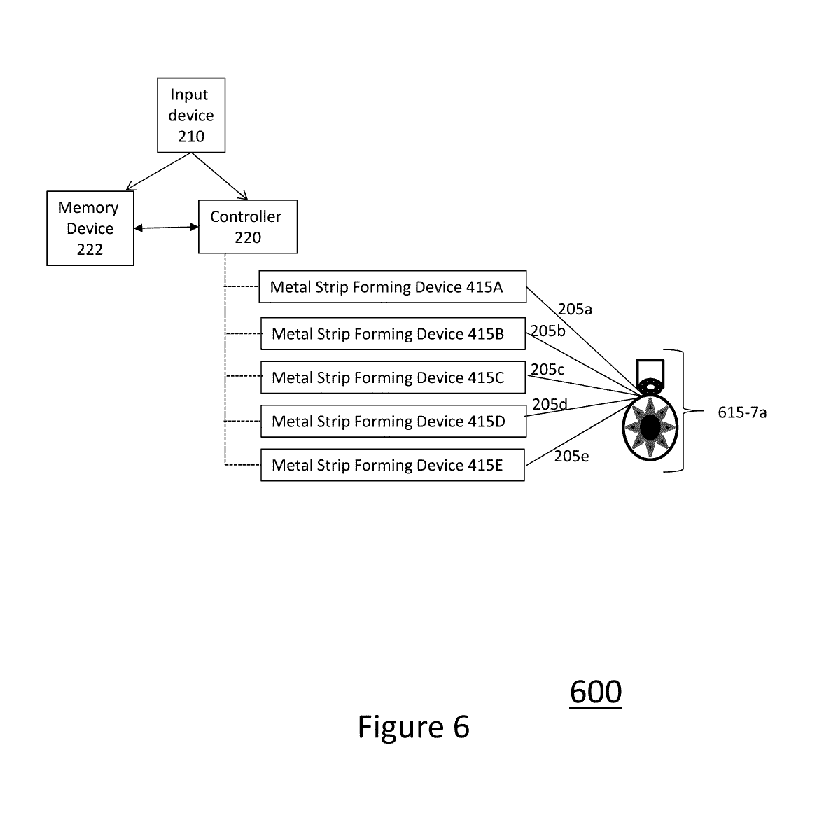

FIG. 6 illustrates a system 600 for forming (e.g., continuously forming) metal strips 205 (e.g., metal strips, conductors, wires, transmission lines, etc.), according to another exemplary aspect of the present invention.

As illustrated in FIG. 6, the system 600 may provide multiple feeds of fully processed metal strips 205. In particular, the system 600 may include an input device 210, controller 220 which may select a metal rod from among a plurality of metal rods based on input parameters (e.g., parameters input by the user) and memory device 222, all of which are discussed above.

The system 600 may also include a plurality of metal strip forming devices 415A-415E which have all of the features and functions of the metal strip forming device 415 described above with reference to FIG. 4A (e.g., and FIG. 5A). In particular, each of the metal strip forming devices 415A-415E may include the feeding section 415-1 which feeds (e.g., pushes) the metal rod through the various sections of the metal strip forming device 415, the guiding section 415-2 which guides the selected metal rod out of the feeding section 415-1, the preheating section 415-3 which preheats the selected metal rod, the forming section 415-4 which forms the selected metal rod into a metal strip, the annealing section 415-5 which anneals the metal strip, the patterning section 415-6 which patterns the annealed metal strip, and the receiving device 415-7a (e.g., receiving roll, cylinder, spool, etc., and a motor for rotating the receiving roll, cylinder, spool, etc.) which receives the metal strip from the patterning section 415-6.

Alternatively, as illustrated in FIG. 6, the receiving device 415-7a may be omitted from each of the metal strip forming devices 415A-415E, and instead the system 600 may include one receiving device 615-7a which receives the plurality of metal strips 205a-f which exit the patterning section 415-6 in each of the metal strip forming devices 415A-415E.

The controller 220 may independently control the plurality of metal strip forming devices 415A-415E, so that the metal strips 205a-205f formed therein have different properties. For example, the metal strip forming device 415A may form a copper strip 205a having a first width and first thickness, the metal strip forming device 415B may form a copper strip 205b having a second width and second thickness, which are different from the first width and first thickness, and so on.

The controller 220 may also coordinate control among the plurality of metal strip forming devices 415A-415E. For example, the controller 220 may set the feed rate in the metal strip forming device 415A to be the same as the feed rate in the metal strip forming device 415B, and so on.

It should be noted that the plurality of metal strips 205a-205f which are formed by the plurality of metal strip forming devices 415A-415E, respectively, may be received on the receiving device 615-7a in a horizontal (e.g., side-by-side) arrangement, or in a vertical arrangement, or in a combined horizontal and vertical arrangement. For example, in the vertical arrangement, the metal strips 205 may be stacked on top of each other, and may be separated by a separating layer such as a dielectric layer. Thus, for example, where the receiving device 615-7a is a spool, the plurality of metal strips 205a-205f may be rolled onto the spool with a separating layer formed between each of the metal strips 205a-205f.

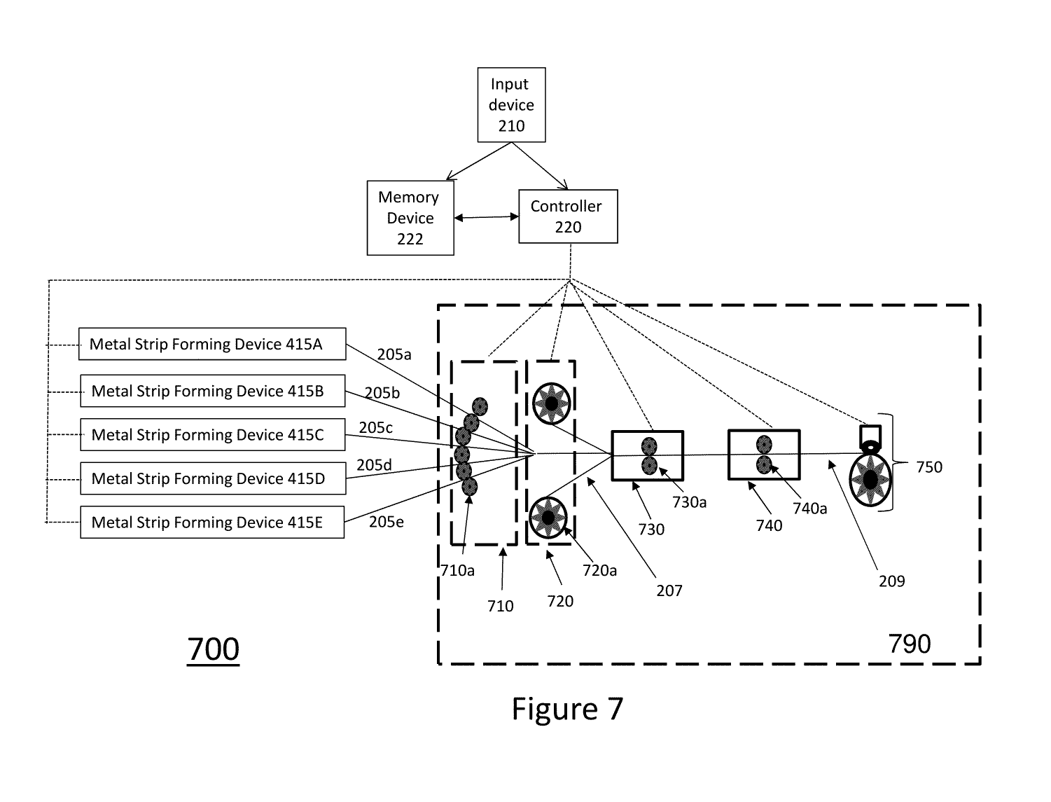

FIG. 7 illustrates a system 700 for forming (e.g., continuously forming) an electrical wire or transmission line, according to an exemplary aspect of the present invention.

As illustrated in FIG. 7, the system 700 may combine one or more metal strip forming devices 415A-415E with a wire/line forming device 790, to fabricate a completed electrical wire or transmission line 209, such as those illustrated FIGS. 1A-1D.

The wire/line forming device 790 may include a feeding section 710 which is controlled by the controller 220, and feeds the plurality of metal strips 205a-205e from the metal strip forming devices 415A-415E into the wire/line forming device 790. The feeding section 710 may include a plurality of guide rollers 710a to guide the plurality of metal strips 205a-205e into the wire/line forming device 790.

Importantly, the plurality of guide rollers 710a in the feeding section 710 may have a configuration for arranging the metal strips 205a-205e to have a configuration as desired in the electrical wire or transmission line 209. For example, the plurality of guide rollers 710a may be configured to arrange the plurality of metal strips 205a-205e to be aligned vertically or horizontally, or some combination of vertical and horizontal arrangement.

The wire/line forming device 790 may also include a dielectric layer application section 720 which is controlled by the controller 220, and may apply one or more dielectric layers 207 onto, under, or between the plurality of metal strips 205a-205e. The dielectric layers 207 may include, for example, a polyester film (e.g., Dupont Mylar®)), a urethane film, a teflon film, etc.

The dielectric layer application section 720 may include, for example, one or more dielectric layer holding structures 720a (e.g., cylinder, spool, etc.) around which the dielectric layer 207 is wound, and which is caused to rotate by the controller 220 in order to apply the dielectric layer 207 onto, under or between the plurality of metal strips 205a-205e.

The wire/line forming device 790 may also include a pressing section 730 which is controlled by the controller 220, and which presses the dielectric layers 207 onto, under or between the plurality of metal strips 205, to form the electrical wire or transmission line 209.

The pressing section 730 may use pressure and/or heat to bond the dielectric layers 207 together with the plurality of metal strips 205a-205e. For example, the pressing section 703 may include pressing rollers 730a (e.g., heated pressing rollers) which apply pressure on opposing sides of the dielectric layers 207 together with the plurality of metal strips 205a-205e (e.g., above and below the dielectric layers 207 and the plurality of metal strips 205a-205e.

The wire/line forming device 790 may also include an adhesive application section 740 which is controlled by the controller 220, and may apply an adhesive to one or more sides of the electrical wire or transmission line 209. The adhesive may include a contact adhesive such as an adhesive tape (e.g., 3M® 9500PC), a liquid adhesive, or a combination of the two. The adhesive application section 740 may include one or more adhesive application rollers 740a which contact at least one of an upper and lower surface of the electrical wire or transmission line 209 to apply the adhesive thereto.

It should be noted that the wire/line forming device 790 may include another adhesive application section 740 which is arranged between the feeding section 710 and the dielectric layer application section 720 in order to apply the adhesive between the plurality of metal strips 205a-205e and the dielectric layers 207. It should also be noted that in some applications, the user may not desire to apply an adhesive to the electrical wire or transmission line 209 and in this case, the controller 220 may deactivate (e.g., disengage) the adhesive application section 740.

The wire/line forming device 790 may also include a receiving device 750 which is controlled by the controller 220, and may take up the electrical wire or transmission line 209 from the adhesive application section 740.

Similar to the system 600, the system 700 may be configured to arrange the plurality of metal strips 205a-205f vertically in the electrical wire or transmission line 209, horizontally in the electrical wire or transmission line 209, or in a combined horizontal and vertical arrangement.

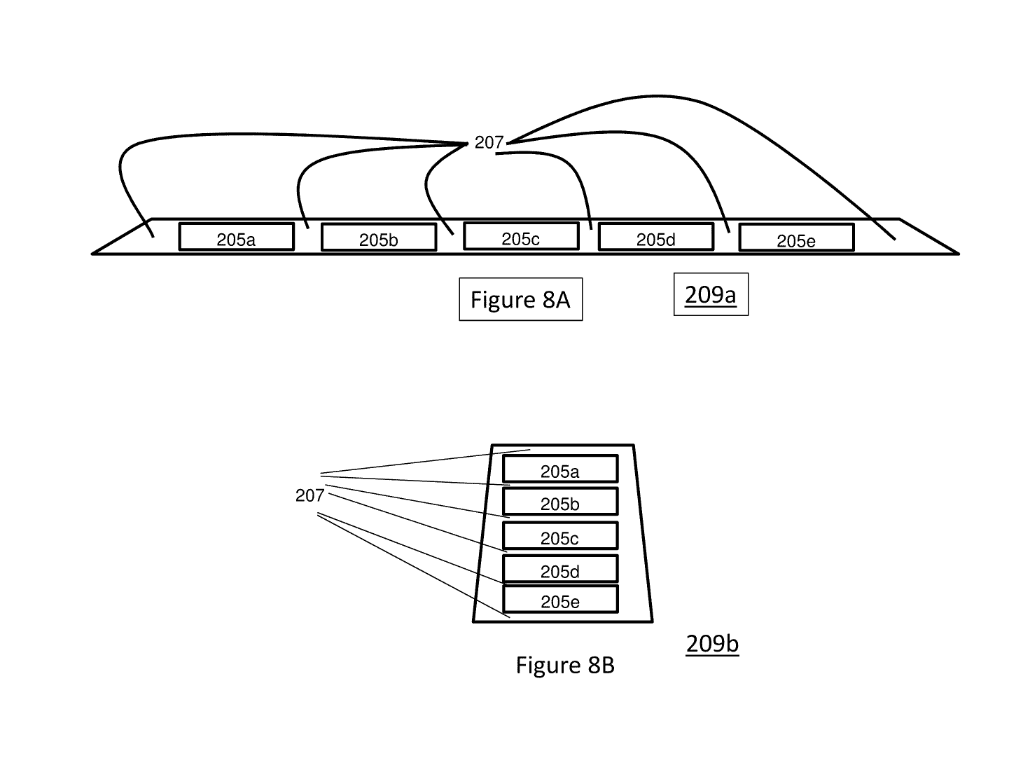

FIG. 8A illustrates an electrical wire or transmission line 209a, according to an exemplary aspect of the present invention, and FIG. 8B illustrates an electrical wire or transmission line 209b, according to an exemplary aspect of the present invention

In the electrical wire or transmission line 209a, the plurality of metal strips 205a-205e are arranged horizontally with dielectric layer 207 formed therebetween, and in the electrical wire or transmission line 209b, the plurality of metal strips 205a-205e are arranged vertically with the dielectric layers 207 formed therebetween.

It should be noted that in FIGS. 8A and 8B, the plurality of metal strips 205a-205e are illustrated as having the same thickness, however, this is not required. Indeed, the plurality of metal strips 205a-205e may have the same or different widths and thicknesses in the electrical wire or transmission line 209.

In addition, although FIG. 7 illustrates the system 700 including five (5) metal strip forming devices 415A-415E, the system 700 may include any number of metal strip forming devices. Further, although FIGS. 8A-8B illustrate the electrical wire or transmission line 209a, 209b having five (5) metal strips, the electrical wire or transmission line 209 may include any number of metal strips.

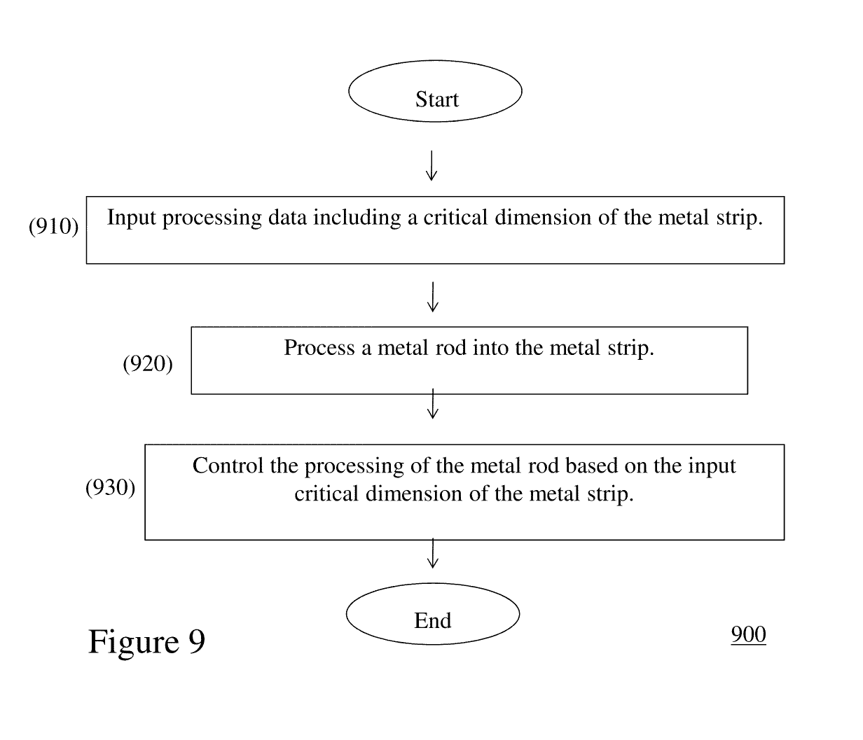

Referring again to the drawings, FIG. 9 illustrates a method 900 of forming a metal strip, according to an exemplary aspect of the present invention.

As illustrated in FIG. 9, the method 900 includes inputting (910) processing data including a critical dimension of the metal strip, processing (920) a metal rod into the metal strip, and controlling (930) the processing of the metal rod based on the input critical dimension of the metal strip.

### Computer Readable Storage Medium

Referring to FIGS. 1-9, another aspect of the present invention is directed to a computer program product which may include, for example, a computer readable storage medium (hereinafter, the “storage medium”) that may store computer readable program instructions (hereinafter, the “computer program” or “instructions”) for performing the features and functions of the present invention (e.g., system 200, 300, 400, 600 and 700) and performing the method 900. That is, the storage medium may store the instructions thereon for causing a processing device (e.g., computer, instruction execution device, computing device, computer processor, central processing unit (CPU), microprocessor, etc.) to perform a feature or function of the present invention.

The storage medium can be a tangible device that can retain and store the instructions for execution by the processing device. The storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The storage medium, as used herein, should not be construed as merely being a “transitory signal” such as a radio wave or other freely propagating electromagnetic wave, an electromagnetic wave propagating through a waveguide or other transmission media (e.g., light pulses passing through a fiber-optic cable), or an electrical signal transmitted through a wire.

The processing device can access the instructions on the storage medium. Alternatively, the processing device can access (e.g., download) the instructions from an external computer or external storage device via a network such as the Internet, a local area network, a wide area network and/or a wireless network.

The network may include, for example, copper transmission cables, optical transmission fibers, wireless transmission, routers, firewalls, switches, gateway computers and/or edge servers. For example, the processing device may include a network adapter card or network interface which receives the instructions from the network and forwards the instructions to the storage medium within the processing device which stores the instructions.

The instructions for performing the features and functions of the present invention may include, for example, assembler instructions, instruction-set-architecture (ISA) instructions, machine instructions, machine dependent instructions, microcode, firmware instructions, state-setting data, or either source code or object code written in one or more programming languages (or combination of programming languages), including an object oriented programming language such as Java, Smalltalk, C++ or the like, and conventional procedural programming languages, such as the “C” programming language or similar programming languages.

The instructions may execute entirely on the processing device (e.g., a user's computer), partly on the processing device, as a stand-alone software package, partly on the processing device and partly on a remote computer or entirely on the remote computer or a server. For example, the instructions may execute on a remote computer which is connected to the processing device (e.g., user's computer) through a network such as a local area network (LAN) or a wide area network (WAN), or may execute on an external computer which is connected to the processing device through the Internet using an Internet Service Provider.

The processing device may include, for example, electronic circuitry including, for example, programmable logic circuitry, field-programmable gate arrays (FPGA), or programmable logic arrays (PLA) that may execute the instructions by utilizing state information of the instructions to personalize the electronic circuitry, in order to perform a feature or function of the present invention.

It should be noted that the features and functions of the present invention which are described above with reference to FIGS. 1-9 may be implemented by the processing device executing the instructions. That is, each block of the flowchart illustrations and/or block diagrams, and combinations of blocks in the flowchart illustrations and/or block diagrams, can be implemented by processing device executing the instructions.

The instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

That is, the instructions may be executed by a processing device to cause a series of operational steps to be performed by the processing device to produce a computer-implemented process, so that the executed instructions implement the features/functions/acts described above with respect to the flowchart and/or block diagram block or blocks of FIGS. 1-9.

Thus, the flowchart and block diagrams in the FIGS. 1-9 illustrate not only a method, system, apparatus or device, but also illustrate the architecture, functionality, and operation of the processing device executing the instructions. In this regard, each block in the flowchart or block diagrams may represent a module, segment, or portion of the instructions, which comprises one or more executable instructions for implementing the specified logical function(s). In some alternative implementations, the features or functions in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Examples

Referring again to FIG. 7, the electrical wire or transmission line 209 produced by the system 700 may be configured as in FIGS. 1A-1D (e.g., Flatwire). In particular, the metal strip forming devices 415A-415E may be arranged at the front end of FlatWire wire producing machinery (e.g., wire/line forming device 790). Thus, the metal strip forming devices 415A-415E should have the smallest footprint possible.

The system 700 may include, for example, a FlatWire web process which creates approximately 3 to 4 million feet of 120/230 VAC electrical FlatWire per month. Each electrical wire 209 in the Flatwire includes four 17 AWG and one 14 AWG conductors each per foot.

The FlatWire web machine (e.g., system 700) could be optimized for greater output. Unlike conventional wire, FlatWire (e.g., electrical wire 209) is more footage-based than pounds or tonnage-based. Preliminary calculations indicate a system 700 may have the ability to process approximately 100 thousand pounds or greater of metal rod 201 (based on copper weights) per month. Designing the system's capacities based on greatest multiple variable efficiencies and applications is preferable.

The current cost for annealed thin strip copper strips (e.g., metal strips 205) in FlatWire's required dimensions ranges from 2 to 5 times more than the equivalent copper rod of the same gauge or circular mil equivalent. This depends on various factors from thickness to width as well as surface preparation, metal grade, hardness and other surface requirements.

The system 700 may also have considerable applications for other industries and markets including conventional wires, flex circuits, shielding, automotive, OEM, “green technologies” and many other applications.

There are many types of FlatWire. This particular example is based on the royalty potential of the patented standard voltage electrical (120/230 VAC, 15 AMP) FlatWire.

The five conductive layers of FlatWire's standard voltage electrical FlatWire utilize approximately one (1) pound of total thin strip copper per twenty-six (2 6) feet.

If copper is priced at four dollars ($4.00) per pound (COMEX copper price), the properly processed thin strip copper for FlatWire manufacturing cost is approximately twelve dollars ($12.00), or higher, per pound. Thus, the sourced thin strip copper cost without transportation, damage losses and other hidden costs is approximately forty-six cents ($0.46) per foot.

If the present invention (e.g., system 400, system 600, system 700, etc.) were available and FlatWire manufacturing sourced 14 AWG copper rod for four dollars and forty cents ($4.40) per pound, the per foot cost of thin strip copper (e.g., metal strip 5) formed by the present invention would be approximately seventeen cents ($0.17) per foot.

If an owner added a fifty-cent ($0.50) per pound royalty for the copper from the system 200, it would add approximately two cents ($0.02) per foot to the cost of this version of FlatWire. The thin strip copper from the present invention and royalty would have a total price of nineteen cents ($0.19) per foot. The thin strip copper from the system 200 would have a net savings per foot of FlatWire that would be twenty-seven cents ($0.27) per foot, or approximately a fifty-nine percent (59%) cost reduction.

The thirty-nine cent ($0.27) per foot savings would create an annual FlatWire standard voltage electrical manufacturing cost reduction (per each FlatWire SVE manufacturing machine) of eleven million three hundred and forty thousand dollars ($11,340,000.00). This means the purchase cost of the present invention should be easily amortized in well under a year.

Based on this model, a single market based FlatWire standard voltage electrical manufacturing machines production capability of approximately three million five hundred thousand (3,500,000) feet per month would gross a royalty of fifty-cents per pound, and would create a gross royalty of approximately seventy-thousand dollars ($70,000.00) per month or eight hundred and forty thousand dollars ($840,000.00) per year per FlatWire SVE machine.

With its unique and novel features, the present invention provides a system and method of forming a metal strip which is more efficient (e.g., less costly) and effective than the conventional systems and methods of forming a metal strip.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive device is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A system for forming a metal strip, comprising:
an input device for inputting processing data including a critical dimension of the metal strip;
a metal strip forming device for processing a metal rod into the metal strip; and
a controller for controlling the metal strip forming device based on the input critical dimension of the metal strip.

2. The system of claim 1, wherein the controller selects the metal rod from among a plurality of metal rods.

3. The system of claim 2, further comprising:
a memory device for storing a look-up table which correlates the critical dimension of the metal strip to a type and size of metal rod,
wherein the controller selects the metal rod by referring to the look-up table.

4. The system of claim 1, wherein the metal rod comprises a pre-manufactured metallic rod of specific gauge and type.

5. The system of claim 1, wherein the metal strip comprises an application-specific and dimensionally correct continuous thin strip metal.

6. The system of claim 1, further comprising a pre-heater for preheating the metal rod.

7. The system of claim 1, wherein the metal strip comprises a fully annealed and cleaned metal strip which is pre-treated for another manufacturing stage as part of an inline process.

8. The system of claim 1, wherein the metal strip comprises a thickness in a range from 0.02 mm to 0.9 mm, and a width in a range from 2.5 mm to 330 mm.

9. The system of claim 1, wherein the metal rod comprises a substantially circular cross-section, and includes a diameter in a range from 0.255 mm to 11.684 mm.

10. The system of claim 1, wherein the metal strip forming device comprises:
a preheater for preheating the metal rod; and
a metal rod feeder for feeding the metal rod from a reel of the metal rod, to the preheater.

11. The system of claim 1, wherein the metal strip forming device further comprises:
a forming device which includes a plurality of forming rollers for transforming the preheated metal rod into the metal strip.

12. The system of claim 1, wherein the metal strip forming device comprises:
an annealing device which is controlled by the controller such that an anneal of the metal strip is in a range from fully hard to fully annealed.

13. A method of forming a metal strip, comprising:
inputting processing data including a critical dimension of the metal strip;
processing a metal rod into the metal strip; and
controlling the processing of the metal rod based on the input critical dimension of the metal strip.

14. The method of claim 13, wherein the controlling of the processing of the metal rod comprises selecting the metal rod from among a plurality of metal rods.

15. The method of claim 14, further comprising:
storing a look-up table which correlates the critical dimension of the metal strip to a type and size of metal rod,
wherein the selecting of the metal rod comprises selecting the metal rod by referring to the look-up table.

16. A system for forming an electrical wire or transmission line, comprising:
an input device for inputting processing data including a critical dimension of the metal strip;
a metal strip forming device for processing a metal rod into the metal strip;
a wire/line forming device which receives the metal strip from the metal strip forming device, and forms the electrical wire or transmission line from the metal strip; and
a controller for controlling the metal strip forming device based on the input critical dimension of the metal strip, and controlling with wire/line forming device in coordination with a control of the metal strip forming device.

17. The system of claim 16, wherein the metal strip forming device comprises a plurality of metal strip forming devices, the metal rod comprises a plurality of metal rods and the metal strip comprises a plurality of metal strips.

18. The system of claim 17, wherein the wire/line forming device comprises:
a feeding section comprising a plurality of guide rollers which are configured to arrange the plurality of metal strips to be aligned at least one of vertically or horizontally;
a dielectric layer application section for applying a dielectric layer onto the plurality of metal strips; and
a pressing section for pressing the dielectric layer onto the plurality of metal strips.

19. The system of claim 16, wherein the controller selects the metal rod from among a plurality of metal rods.

20. The system of claim 19, further comprising:
a memory device for storing a look-up table which correlates the critical dimension of the metal strip to a type and size of metal rod,
wherein the controller selects the metal rod by referring to the look-up table.
